(19) United States
(12) Patent Application Publication
(10) Pub. No.: US 2008/0107862 A1
(43) Pub. Date: May 8, 2008

(54) Ceiling Fan Blade

(76) Inventor: Hsien-Chin LIAO, Taichung City (TW)

Correspondence Address: Dr. BANGER SHIA, 102 Lindencrest Ct., Sugar Land, TX, 77479-5201, US

(21) Appl. No.: 11/934,061

(22) Filed: Nov. 1, 2007

(30) Foreign Application Priority Data
Nov. 8, 2006 (TW) 095219744

(51) Int. Cl. B32B 5/12

(52) U.S. Cl. 428/106

(57) ABSTRACT

A ceiling fan blade sequentially comprises a patterned layer and a shining layer on a surface thereof. The blade is only attached with two layers, reducing the working procedures. The shining layer uses the thermosetting powder coating to be thermally fixed on the blade by heating without using the solvent which will pollute the environment, so the ceiling blade is more environment-friendly.

### BACKGROUND OF THE INVENTION

1. Field of the Invention

The present invention relates to a ceiling fan blade, and more particularly to an improved ceiling fan blade.

2. Description of the Prior Art

Referring to FIGS. 1-2, one side A of a conventional fan blade 10 comprises a patterned paper layer 11, three adhesive paint layers 12 and a shining paint layer 13. The patterned paper layer 11 is attached to a surface A of the fan blade 10. The three adhesive paint layers 12 are formed on a surface of the patterned paper layer 11 by spraying. The shining paint layer 13 is formed on the surface of the three adhesive paint layers 12 by spraying.

Since the blade 10 is made of wood, the surface A of the blade 10 must be rubbed flat at the time of attaching the patterned paper layer 11. Additionally, since the shining paint layer 13 is difficult to be attached to the patterned paper layer 11, the patterned paper layer 11 must be sprayed with three adhesive paint layers 12, so that the shining paint layer can be attached to the surface of the three adhesive paint layers 12. The cost must be increased due to the fussy working procedures.

Furthermore, the three adhesive paint layers 12 and the shining paint layer 13 must be used with the solvent. However, since there is lead in the solvent, the environment will be polluted and the solvent itself will cause the damage to the human being.

In addition, the patterned paper layer 11 is attached on the surface A of the blade 10. Even though the patterned paper layer 11 is sprayed with s adhesive paint layer 12 and the shining paint layer 13, it still can be disrupted due to scraping, leading to an unbeautiful appearance. After the blade 10 is attached to the patterned paper layer 11, unfortunately, the primary color of the wood material will lose.

Additionally, the side surface B of the blade 10 has a quite small area, and the side surface B is unlikely to be attached to the patterned paper layer 11, thus causing the side surface B not so beautiful.

The present invention has arisen to mitigate and/or obviate the afore-described disadvantages.

### SUMMARY OF THE INVENTION

The primary objective of the present invention is to provide a ceiling fan blade which is simplified in the working procedures.

The second objective of the present invention is to provide a ceiling fan blade which is more environment-friendly in the fabrication.

The ceiling fan blade of the present invention sequentially comprises a patterned layer and a shining layer on a surface thereof. The patterned layer is directly pressed on the surface of the blade, and the shining layer is thermally fixed on the surface of the patterned layer. By such arrangements, the working procedures of the blade is simplified, and the shining layer is avoided of using the solvent which will pollute the environment.

### BRIEF DESCRIPTION OF THE DRAWINGS

FIG. 1 is a perspective view of a conventional ceiling fan blade;

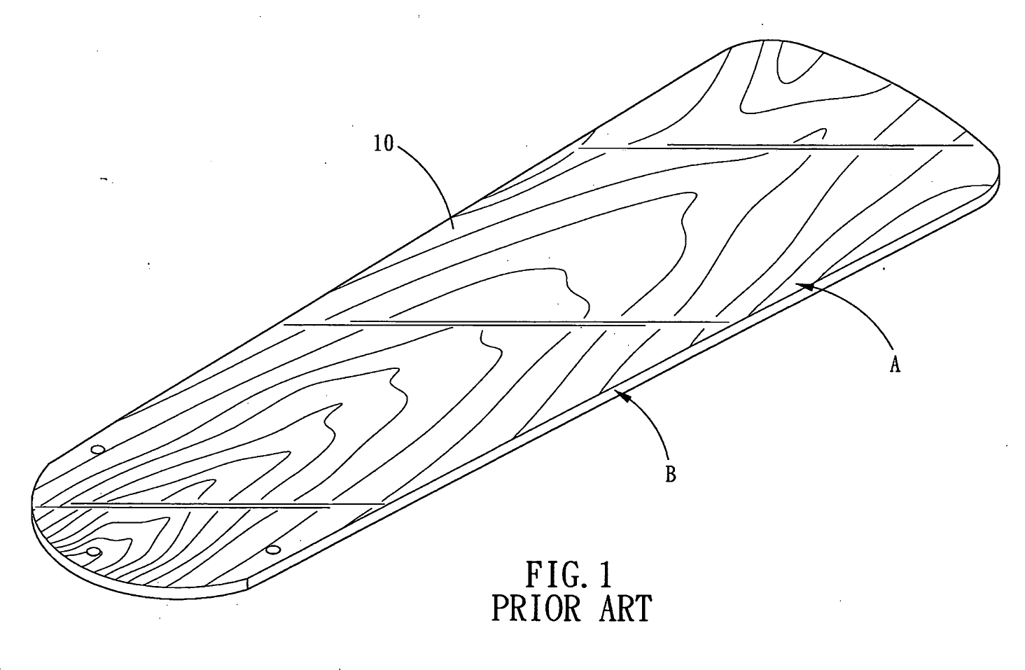

FIG. 2 is a partial cross sectional view of the conventional ceiling fan blade;

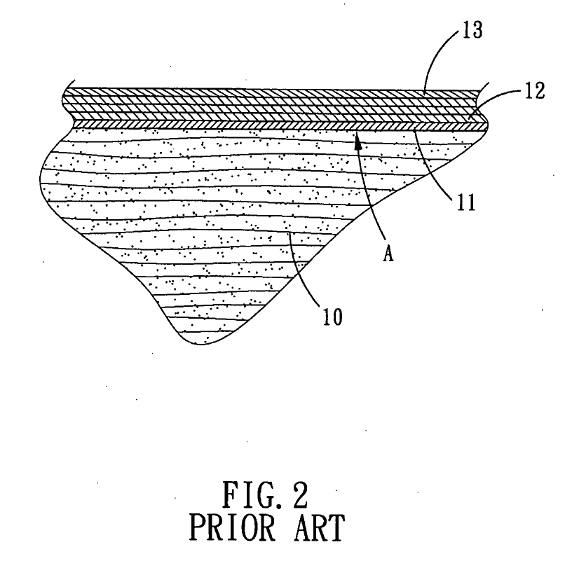

FIG. 3 is a perspective view showing a ceiling fan blade in accordance with the present invention is being installed on the ceiling fan;

FIG. 4 is a perspective view of the ceiling fan blade in accordance with the present invention; and

FIG. 5 is a partial cross sectional view of the ceiling fan blade in accordance with the present invention.

### DETAILED DESCRIPTION OF THE PREFERRED EMBODIMENTS

The present invention will be clearer from the following description when viewed together with the accompanied drawings, which show, for purpose of illustrations only, the preferred embodiment in accordance with the present invention.

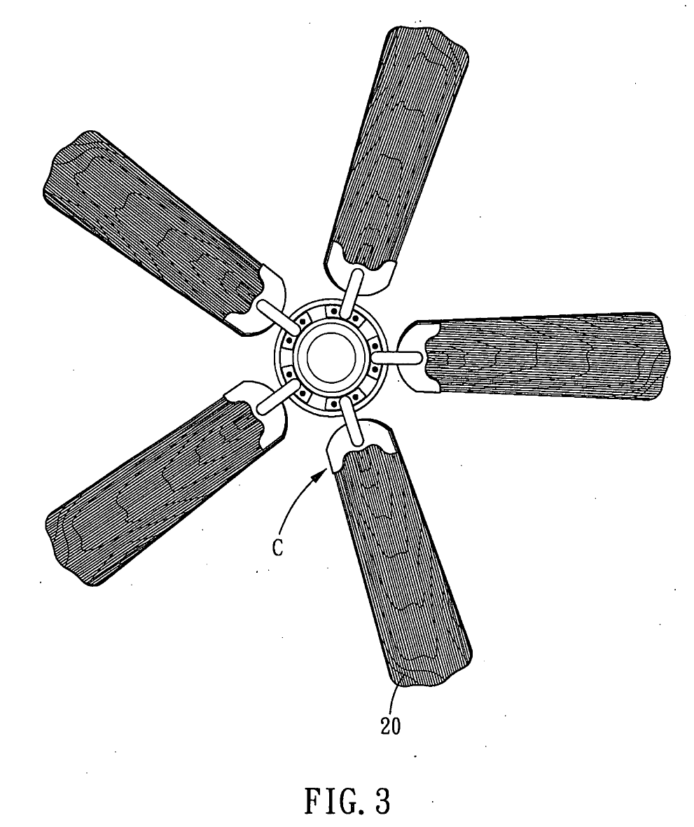

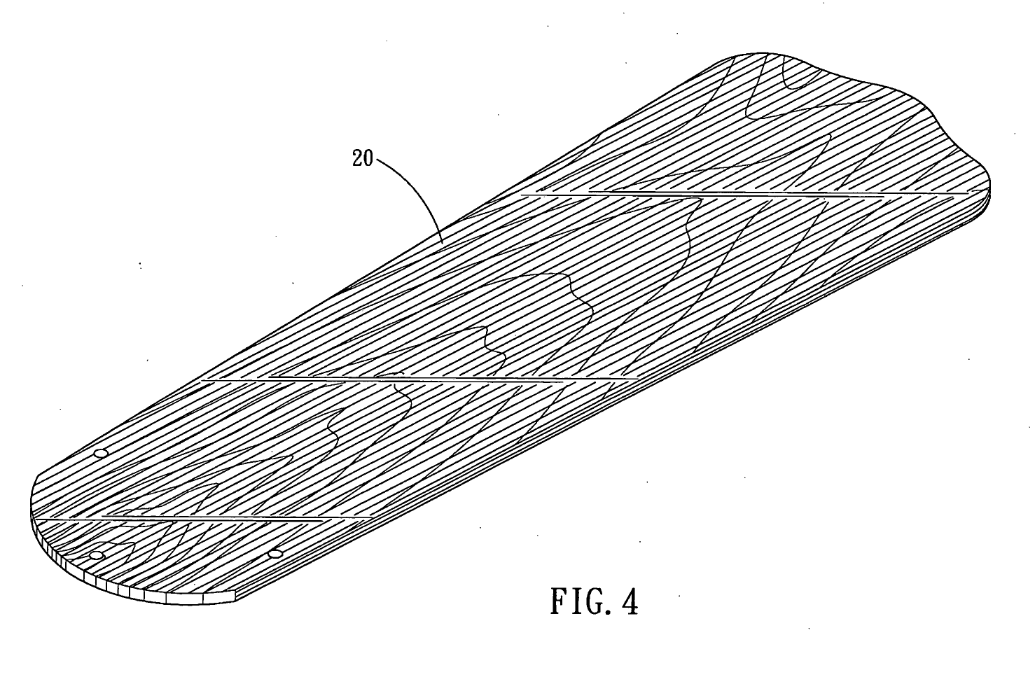

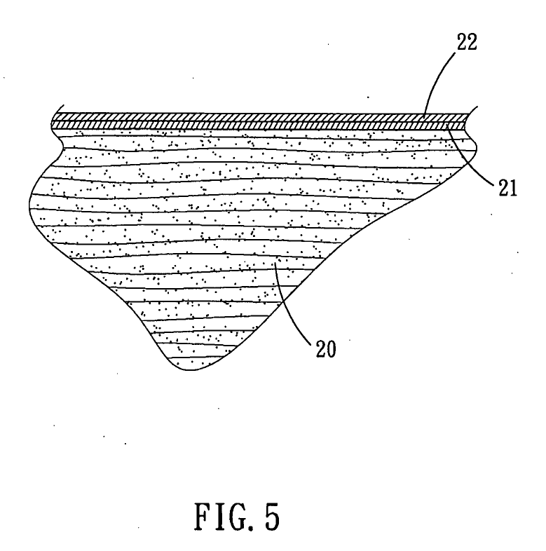

Referring to FIGS. 4-5, a fan blade 20 which is installed on the ceiling fan C (as shown in FIG. 3) in accordance with a preferred embodiment of the present invention is made of wood and sequentially comprises:

A patterned layer 21 pressed on the surface of the fan blade 20; and

A shining layer 22 which is made of a thermosetting powder coating such as unsaturated polyester or epoxy resin, after being sprinkled on the surface of the patterned layer 21, the shining layer 22 is thermally fixed on the surface of the patterned layer 21 by heating.

As known from the above, the blade 20 is only required to be pressed with the patterned layer 21 and finished by thermally fixing the shining layer 22. However, the surface A of the conventional blade 10 is attached with patterned paper layer 11, and then sequentially sprayed with the three adhesive paint layers 12 and the shining paint layer 13. As known from the comparison, the shining layer 22 of the present invention is thermally fixed on the surface of the blade 20 after being sprinkled. However, the conventional shining paint layer 13 is attached after the three adhesive paint layers 12 being sprayed, so that it can enhance the adhesive force. Thus, it is obvious that the working procedures in accordance with the present invention are more simplified and fast.

Furthermore, the shining layer 22 is thermally fixed on the surface of the blade 20 after being sprinkled. However, the three adhesive paint layers 12 and the shining paint layer 13 of the conventional blade 10 must use the solvent which will cause the pollution in the environment. In addition, the thermosetting powder coating used in the shining layer 22 of the present invention is still in powder state before being heated, so the surplus powder can be recycled, while the paint and the solvent used on the conventional blade 10 cannot be recycled. Therefore, the ceiling fan blade of the present invention is more environment-friendly than the conventional blade.

In addition, the patterned layer 21 of the present invention is directly pressed on the surface of the blade 20, so it won't be broken like the patterned paper layer 11. Thus, the blade of the present invention is more durable and beautiful.

Additionally, the conventional blade 10 is attached on the surface thereof with the patterned paper layer 11, and the side surface B of the blade 10 is unlikely to be attached to the patterned paper layer 11 due to its excessively small area, thus affecting the appearance of the blade 10 because of the sharp contrast between the two sides. The overall blade 20 of the present invention has the primary color of the wood, and further the blade 20 is pressed on the surface thereof with the patterned layer 21, so that the appearance of the blade 20 is more natural and beautiful.

To summarize, the ceiling fan blade of the present invention is improved. The blade of the present invention sequentially comprises a patterned layer and a shining layer on the surface thereof. By comparing with the conventional blade which comprises a patterned paper layer, three adhesive paint layers and a shining paint layer, the present invention only comprises the patterned layer and the shining layer, so the present invention is much simpler in the fabrication. Additionally, the three adhesive paint layers and the shining layer of the conventional blade must use the solvent which will pollute the environment, while the shining layer of the present invention uses the thermosetting powder coating to be thermally fixed on the blade without using the solvent which will pollute the environment, so the present invention is more environment-friendly.

While we have shown and described various embodiments in accordance with the present invention, it is clear to those skilled in the art that further embodiments may be made without departing from the scope of the present invention.

What is claimed is:

1. A ceiling fan blade which is made of wood, sequentially comprising on a surface thereof:
a patterned layer being pressed on the surface of the blade; and
a shining layer being thermally fixed on a surface of the patterned layer by heating, the shining layer being made of a thermosetting powder coating.

2. The ceiling fan blade as claimed in claim 1, wherein the shining layer is made of unsaturated polyester.

3. The ceiling fan blade as claimed in claim 1, wherein the shining layer is made of epoxy resin.
